(19) United States
(12) Patent Application Publication
(10) Pub. No.: US 2011/0229110 A1
(43) Pub. Date: Sep. 22, 2011

(54) MOTION PICTURE EDITING APPARATUS AND METHOD, AND COMPUTER PROGRAM

(75) Inventor: Motooki Sugihara, Saitama (JP)

(73) Assignee: PIONEER CORPORATION, TOKYO (JP)

(21) Appl. No.: 12/671,916

(22) PCT Filed: Aug. 8, 2007
(86) PCT No.: PCT/JP2007/065542

§ 371 Date: May 24, 2010

(51) Int. Cl. H04N 5/93

(52) U.S. Cl. 386/278; 386/E05.028

(57) ABSTRACT

A moving image editing device (100) includes a moving image analysis element (200) for analyzing a moving image to obtain the feature of the moving image, a specifying element (310) capable of specifying the feature of a scene to be identified as an editing target in the moving image, an identifying element (320) for identifying a scene having the feature matching the specified feature in the moving image as the editing target, and a presenting element (400) for presenting scene information including the start and ending time of the identified scene in the moving image.

### TECHNICAL FIELD

The present invention relates to a motion picture editing apparatus for and method of editing a motion picture, such as video, recorded by a video camera or the like, as well as a computer program which makes a computer function as such a motion picture editing apparatus.

### BACKGROUND ART

An operation of editing video filmed or recorded by a video camera is widely performed not only by experts but also by the general public. The video editing is generally performed by using equipment for exclusive use or a personal computer after the recording or filming.

In the video editing, such operations are performed that the recorded video is reproduced and that the video is cut at the start point and end point of an unnecessary scene (or a scene a user desires to save) while the a user confirms the content of the video to delete the unnecessary scene. In such operations, the user needs to confirm almost all the video content. Thus, particularly if the video time is long, such as over several ten minutes or 1 hour, a time and energy or effort required for the operations increase, which is problematic. This almost or completely discourages the user from performing the video editing, and the user tends to save the recorded video as it is on a recording medium, such as a digital video tape, a DVD, and a hard disk. The as-recorded video tends to include the unnecessary scene, such as a scene failing to be recorded and a scene needlessly recorded. Thus, the fact that the as-recorded video is saved on the recording medium also leads to such problems that the recording medium is wasted and that the recording medium is not reused.

Therefore, for example, a patent document 1 discloses a technology of automatically deleting the unnecessary scene, such as an unsightly scene caused by an operation error, camera shake, and the like.
Patent document 1: Japanese Patent Application Laid Open No. H05-236411

### DISCLOSURE OF INVENTION

### Subject to be Solved by the Invention

In the technology disclosed in the patent document 1, however, since the unnecessary scene is automatically deleted, if the editing result is different from the user's will, such as a case where the unnecessary scene remains in the editing result and a case where an important scene is deleted, the user has to start the editing over. In addition, the operation required for the re-editing is almost the same as the operation required for the first editing, which is problematic. Thus, even if such an operation is repeated, there is a possibility that the user cannot obtain the desired editing result. Even if the user can obtain the desired editing result, the time and energy or effort required for the operation repeated until the user obtains the desired editing result likely increase.

In view of the aforementioned problems, it is therefore an object of the present invention to provide, for example, a motion picture editing apparatus and method which enables the user to easily perform the editing operation and the confirmation operation, as well as a computer program which makes a computer function as such a motion picture editing apparatus.

### Means for Solving the Subject

The above object of the present invention can be achieved by a motion picture editing apparatus provided with: a motion picture analyzing device for analyzing a motion picture, thereby obtaining characteristics of the motion picture; a specifying device capable of specifying characteristics of a scene to be identified as an editing target, of the motion picture; an identifying device for identifying a scene with characteristics which match the specified characteristics of the motion picture, as the editing target; and a presenting device for presenting scene information including start and end time points of the identified scene of the motion picture.

According to the motion picture editing apparatus of the present invention, in the editing of the motion picture, firstly, the motion picture is analyzed by the motion picture analyzing device, thereby obtaining the characteristics of the motion picture. Here, the “characteristics of the motion picture” in the present invention means the characteristics of the motion picture caused by the filming or recording, such as a camera shake, zoom speed, and panning variation (i.e. variation in a horizontal direction of the motion picture generated in the filming or recording, with a video camera intentionally shaking in the horizontal direction), included in the motion picture filmed or recorded by a video camera or the like. More specifically, the motion picture analyzing device analyzes the characteristics of each of a plurality of frames which constitute the motion picture, for example, such as chromatic characteristics, luminance characteristics, motion characteristics, and spatial frequency characteristics. Incidentally, the obtained characteristics of the motion picture are recorded in a memory device owned by the motion picture analyzing device or externally provided.

Then, if the characteristics of the scene to be identified as the editing target are specified by the specifying device, the scene with the characteristics which match the specified characteristics is identified by the identifying device. In other words, for example, if it is specified as the characteristics of the scene to be identified that the “camera shake” is greater than or equal to a predetermined threshold value from a user by using the specifying device, the identifying device identifies a scene in which the “camera shake” is greater than or equal to the predetermined threshold value, from a plurality of scenes included in the motion picture, on the basis of the characteristics of the motion picture obtained by the motion picture analyzing device. Thus, the user can intuitively or collectively identify the editing target by specifying the characteristics of the scene the user desires to identify as the editing target by using the specifying device.

Then, the scene information including the start and end time points of the scene identified by the identifying device is presented by the presenting device. Here, the “scene information” of the present invention means information for identifying the scene, which includes the start time point at which the scene starts and the end time point at which the scene ends. More specifically, the presenting device presents the scene information by graphically displaying the start and end time points of the identified scene on the screen of the displaying device. Thus, the user can easily perform an operation of confirming the scene identified as the editing target by looking at the presented scene information.

As explained above, according to the motion picture editing apparatus of the present invention, the user can intuitively or collectively identify the editing target by specifying the characteristics of the scene the user desires to identify as the editing target by using the specifying device. Moreover, the user can easily perform the operation of confirming the scene identified as the editing target by looking at the presented scene information. As a result, it is possible to reduce the time and energy or effort required for the user's confirmation operation; namely, the user can easily perform the confirmation operation.

In one aspect of the motion picture editing apparatus of the present invention, the motion picture analyzing device is provided with at least one of characteristic analyzing devices which are: a chromatic characteristic analyzing device for analyzing chromatic characteristics in each of a plurality of frames which constitute the motion picture; a luminance characteristic analyzing device for analyzing luminance characteristics in each of the plurality of frames which constitute the motion picture; a motion characteristic analyzing device for analyzing motion characteristics in each of the plurality of frames which constitute the motion picture; and a spatial frequency characteristic analyzing device for analyzing spatial frequency characteristics in each of the plurality of frames which constitute the motion picture.

According to this aspect, the chromatic characteristic analyzing device analyzes chromatic characteristics in each frame (e.g. a dominant color, color ratio, or the like in each frame). The luminance characteristic analyzing device analyzes luminance characteristics in each frame (e.g. average brightness, maximum brightness, minimum brightness or the like in each frame). The motion characteristic analyzing device analyzes motion characteristics in each frame (e.g. the distribution of overall or local motion vectors between the frame and frames arranged in tandem. The spatial frequency characteristic analyzing device analyzes spatial frequency characteristics in each frame (e.g. the distribution of frequency components in each frame by FFT (Fast Fourier Transform) or DCT (Discrete Cosine Transform). The motion picture analyzing device has at least one of the characteristic analyzing devices which are the chromatic characteristic analyzing device, the luminance characteristic analyzing device, the motion characteristic analyzing device, and the spatial frequency characteristic analyzing device, so that it can certainly obtain the characteristics of the motion picture.

In another aspect of the motion picture editing apparatus of the present invention, the specifying device can specify a type and level of the characteristics of the scene to be identified, and the identifying device judges whether or not the characteristics of the specified type match the specified characteristics on the basis of the specified level.

According to this aspect, the user can identify the scene to be identified as the editing target by specifying the type of the characteristics (e.g. a camera shake, zoom speed, panning variation, or the like) and its level (i.e. the magnitude of a characteristic amount indicating the extent of the characteristics, such as large, medium, and small).

In another aspect of the motion picture editing apparatus of the present invention, it is further provided with: a history holding device for holding a history of the scene information associated with the identified scene; and a comparing device for comparing at least two pieces of scene information included in the held history, thereby extracting a different portion in which the at least two pieces of scene information are different from each other or a common portion in which the at least two pieces of scene information are common with each other, the presenting device further presenting the different portion or the common portion.

According to this aspect, the history holding device holds the history of the scene information associated with the scene identified by the identifying device. In other words, the history holding device records the scene information including the start and end time points of the identified scene into a memory device owned by the history holding device or externally provided, every time the scene is identified by the identifying device. In other words, every time the user specifies the characteristics of the scene to be identified as the editing target by using the specifying device (i.e. every time the user performs one editing operation), the scene which matches the specified characteristics is identified by the identifying device and the scene information associated with the identified scene is held by the history holding device.

The comparing device compares at least two pieces of scene information specified by the user from among a plurality of pieces of scene information included in the held history, thereby extracting the different portion or common portion between the at least two pieces of scene information. In other words, for example, a difference between the scene information associated with the scene identified when the user performs the first editing operation (i.e. when the user firstly specifies the characteristics by using the specifying device) and the scene information associated with the scene identified when the user performs the second editing operation (i.e. when the user secondly specifies the characteristics by using the specifying device) is extracted by the comparing device.

The different portion or common portion extracted in this manner is presented to the user by the presenting device. Thus, the user can recognize the different portion or common portion. Therefore, the user can easily determine the editing operation to be performed next in order to obtain the user's desired editing result, on the basis of the different portion or common portion. As a result, the user can perform the editing operation, more easily.

In another aspect of the motion picture editing apparatus of the present invention, the presenting deice has a reproducing device for reproducing the identified scene.

According to this aspect, the user can confirm the content of the identified scene. Thus, the user can easily judge whether or not the identified scene is the user's desired scene.

In an aspect in which the history holding device and the comparing device are further provided, as described above, the presenting deice may have a reproducing device for reproducing a scene corresponding to the different portion or the common portion.

In this case, the user can confirm the content of the different portion or common portion. Thus, the user can easily determine the editing operation to be performed next in order to obtain the user's desired editing result, for example, by confirming only the content of the different portion between the two pieces of scene information. Here, in particular, in comparison with a case where all the content of the editing result (e.g. the motion picture after automatically deleting an unnecessary scene) is confirmed in each editing operation (e.g. every time the unnecessary scene is automatically deleted from the original motion picture), it is possible to reduce a wasteful confirmation operation, and it is possible to certainly reduce the time and energy or effort required for the editing operation until the user obtains the desired editing result.

Incidentally, the reproducing device may selectively reproduce one portion of the scene corresponding to the different portion or common portion in accordance with the user's instruction.

The above object of the present invention can be also achieved by a motion picture editing method provided with: a motion picture analyzing process of analyzing a motion picture, thereby obtaining characteristics of the motion picture; a specifying process of specifying characteristics of a scene to be identified as an editing target, of the motion picture; an identifying process of identifying a scene with characteristics which match the specified characteristics of the motion picture, as the editing target; and a presenting process of presenting scene information including start and end time points of the identified scene of the motion picture.

According to the motion picture editing method of the present invention, it is possible to receive the same various effects as those received by the aforementioned motion picture editing apparatus of the present invention.

Incidentally, the motion picture editing method of the present invention can also adopt the same various aspects as those of the aforementioned motion picture editing apparatus of the present invention.

The above object of the present invention can be also achieved by a computer program for making a computer function as: a motion picture analyzing device for analyzing a motion picture, thereby obtaining characteristics of the motion picture; a specifying device capable of specifying characteristics of a scene to be identified as an editing target, of the motion picture; an identifying device for identifying a scene with characteristics which match the specified characteristics of the motion picture, as the editing target; and a presenting device for presenting scene information including start and end time points of the identified scene of the motion picture.

According to the computer program of the present invention, the aforementioned motion picture editing apparatus of the present invention can be relatively easily realized as a computer provided in the motion picture editing apparatus reads and executes the computer program from a program storage device, such as a ROM, a CD-ROM, a DVD-ROM, and a hard disk, or as it executes the computer program after downloading the program through a communication device. This enables the user to easily perform the editing operation and the confirmation operation, as in the aforementioned motion picture editing apparatus of the present invention

Incidentally, the computer program of the present invention can also adopt the same various aspects as those of the aforementioned motion picture editing apparatus of the present invention.

As explained in detail above, according to the motion picture editing apparatus of the present invention, it is provided with the motion picture analyzing device, the specifying device, the identifying device, and the present device. According to the motion picture editing method of the present invention, it is provided with the motion picture analyzing process, the specifying process, the identifying process, and the present process. Thus, the user can easily perform the editing operation and the confirmation operation. According to the computer program of the present invention, it makes a computer function as the motion picture analyzing device, the specifying device, the identifying device, and the present device. Thus, the aforementioned motion picture editing apparatus can be constructed, relatively easily.

The operation and other advantages of the present invention will become more apparent from the embodiment explained below.

### BRIEF DESCRIPTION OF DRAWINGS

FIG. 1 is a block diagram conceptually showing the structure of a motion picture editing apparatus in a first embodiment.

FIG. 2 is a conceptual view conceptually showing the format of characteristic data in the first embodiment.

FIG. 3 is a view showing a GUI in a characteristic specification device in the first embodiment.

FIG. 4 is a view with the same concept as in FIG. 3 in a modified example.

FIG. 5 is conceptual view conceptually showing one example of control data in the first embodiment.

FIG. 6 is a conceptual view conceptually showing one example of a history of scene information held by a history holding device in the first embodiment.

FIG. 7 is a view showing one example of display by an editing result display device in the first embodiment.

FIG. 8 is a flowchart conceptually showing the operations of the motion picture editing apparatus in the first embodiment.

FIG. 9 is a flowchart conceptually showing the operations of the motion picture editing apparatus in the first embodiment.

FIG. 10 are views showing one example of an editing result displayed by the editing result display device when a user edits video data by using the motion picture editing apparatus in the first embodiment.

FIG. 11 are views showing one example of the editing result displayed by the editing result display device when the user edits video data by using the motion picture editing apparatus in the first embodiment.

FIG. 12 are views showing one example of the editing result displayed by the editing result display device when the user edits video data by using the motion picture editing apparatus in the first embodiment.

FIG. 13 are views showing one example of the editing result displayed by the editing result display device when the user edits video data by using the motion picture editing apparatus in the first embodiment.

FIG. 14 are views showing one example of the editing result displayed by the editing result display device when the user edits video data by using the motion picture editing apparatus in the first embodiment.

FIG. 15 are views showing one example of the editing result displayed by the editing result display device when the user edits video data by using the motion picture editing apparatus in the first embodiment.

### DESCRIPTION OF REFERENCE CODES

100 video data storage device
200 video analysis device
210 time information extraction device
220 chromatic characteristic analysis device
230 luminance characteristic analysis device
240 motion characteristic analysis device
250 spatial frequency characteristic analysis device
260 characteristic data generation device
270 characteristic data storage device
300 editing control device
310 characteristic specification device
320 scene identification device
330 history holding device
340 history comparison device
400 editing result confirmation device
410 editing result display device
420 reproduction device

### BEST MODE FOR CARRYING OUT THE INVENTION

Hereinafter, an embodiment of the present invention will be explained with reference to the drawings.

### First Embodiment

A motion picture editing apparatus in a first embodiment will be explained.

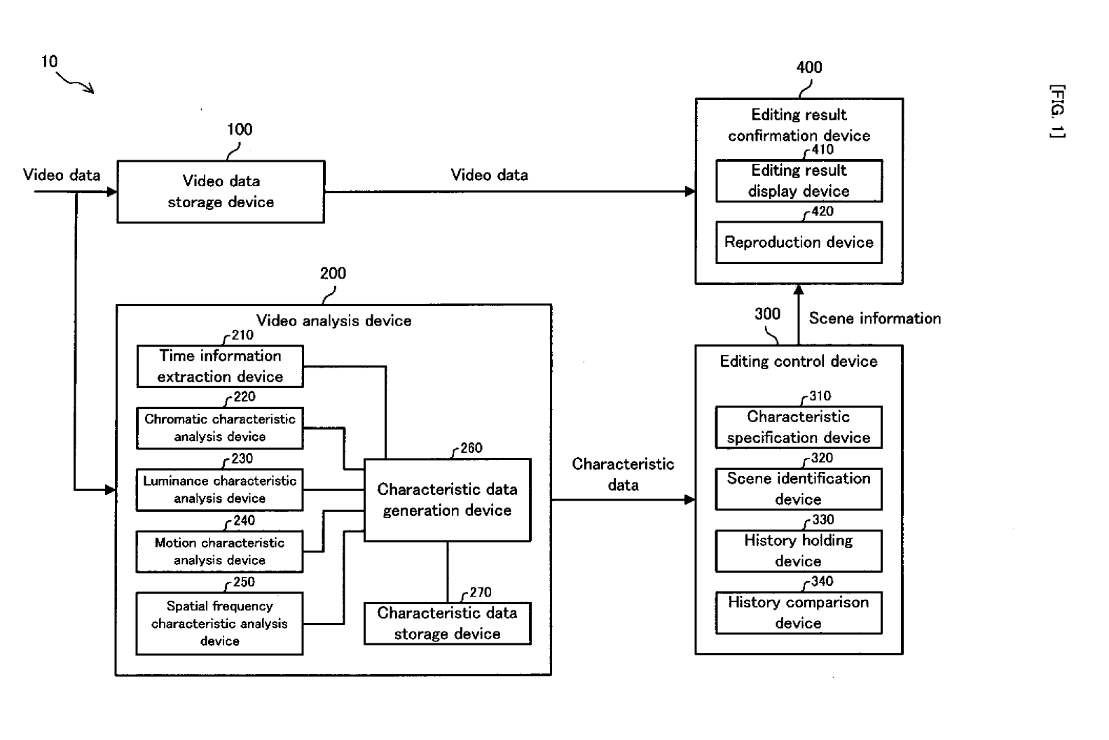

Firstly, the structure of the motion picture editing apparatus in the first embodiment will be explained with reference to FIG. 1. FIG. 1 is a block diagram conceptually showing the structure of the motion picture editing apparatus in the first embodiment.

In FIG. 1, a motion picture editing apparatus 10 in the embodiment is an apparatus for editing data on video (i.e. motion picture) recorded by a video camera or the like.

As shown in FIG. 1, the motion picture editing apparatus 10 is provided with a video data storage device 100, a video analysis device 200, an editing control device 300, and an editing result confirmation device 400.

The video data storage device 100 has the data inputted, wherein the data is about video recorded by the video camera or the like (hereinafter referred to as “video data”), and it accumulates the inputted video data. The video data storage device 100 includes a recording medium, such as a hard disk and a memory.

The video analysis device 200 is one example of the “motion picture analyzing device” of the present invention. The video analysis device 200 has the video data inputted and analyzes the inputted video data, thereby obtaining the characteristics of the video data. More specifically, the video analysis device 200 has a time information extraction device 210, a chromatic characteristic analysis device 220, a luminance characteristic analysis device 230, a motion characteristic analysis device 240, a spatial frequency characteristic analysis device 250, a characteristic data generation device 260, and a characteristic data storage device 270.

The time information extraction device 210 extracts (or separates) time information, such as a frame number and a time code, included in the video data.

The chromatic characteristic analysis device 220 analyzes the characteristics of color (i.e. chromatic characteristics) in each of the plurality of frames which constitute the video associated with the video data. The chromatic characteristic analysis device 220 extracts, for example, a dominant color and a color ratio in each frame, as the chromatic characteristics.

The luminance characteristic analysis device 230 analyzes the characteristics of brightness (i.e. luminance characteristics) in each of the plurality of frames which constitute the video associated with the video data. The luminance characteristic analysis device 230 extracts, for example, average brightness, maximum brightness, and minimum brightness in each frame, as the luminance characteristics.

The motion characteristic analysis device 240 analyzes the characteristics of motion (i.e. motion characteristics) in each of the plurality of frames which constitute the video associated with the video data. The motion characteristic analysis device 240 extracts, for example, camera work information (i.e. a direction and a speed in which the video camera moves) and motion area information (i.e. the number, position, and dimensions of areas moving in the video) in each frame, as the motion characteristics, by analyzing the distribution of overall or local motion vectors between the frame and frames arranged in tandem.

The spatial frequency characteristic analysis device 250 analyzes the characteristics of a spatial frequency (i.e. spatial frequency characteristics) in each of the plurality of frames which constitute the video associated with the video data. The spatial frequency characteristic analysis device 250 calculates a frequency component by FFT or DCT or the like in each of divisional domains to which each frame is divided, and it extracts low-frequency domain information (i.e. the number, position, and dimensions of domains having frequency components that are lower than a predetermined frequency) and high-frequency domain information (i.e. the number, position, and dimensions of domains having frequency components that are higher than a predetermined frequency), as the spatial frequency characteristics.

The characteristic data generation device 260 generates characteristic data on the basis of the time information extracted by the time information extraction device 210 and each of the analysis results (i.e. each of the extracted characteristics) obtained by the chromatic characteristic analysis device 220, the luminance characteristic analysis device 230, the motion characteristic analysis device 240, and the spatial frequency characteristic analysis device 250.

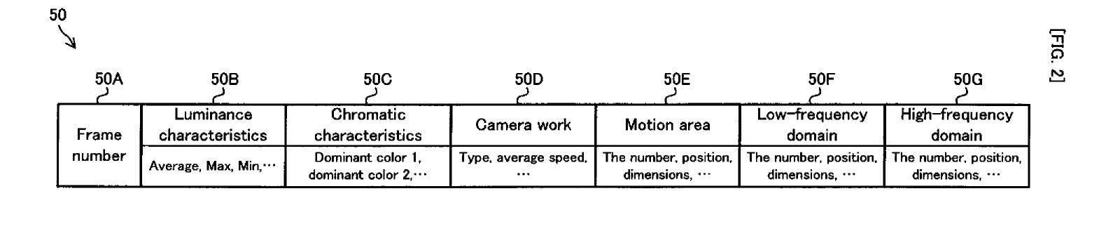

FIG. 2 is a conceptual view conceptually showing the format of the characteristic data in the first embodiment.

As shown in FIG. 2, characteristic data 50 is generated by the characteristic data generation device 260 as the data in which the luminance characteristics, the chromatic characteristics, the camera work information, the motion area information, the low-frequency domain information, and the high-frequency domain information are associated with respect to the frame number. In other words, the characteristic data generation device 260 generates the characteristic data 50 by integrating each of the analysis results analyzed by the chromatic characteristic analysis device 220, the luminance characteristic analysis device 230, the motion characteristic analysis device 240, and the spatial frequency characteristic analysis device 250, by a frame unit. More specifically, in an item 50A associated with the frame number, there is recorded the frame number as the time information extracted by the time information extraction device 210. In an item 50B associated with the luminance characteristics, there are recorded the average brightness, the maximum brightness, and the minimum brightness extracted by the luminance characteristic analysis device 230. In an item 50C associated with the chromatic characteristics, there is recorded the dominant color extracted by the chromatic characteristic analysis device 220. In an item 50D associated with the camera work, there is recorded the camera work information extracted by the motion characteristic analysis device 240. In an item 50F associate with the low-frequency domain, there is recorded the low-frequency domain information extracted by the spatial frequency characteristic analysis device 250. In an item 50G associate with the high-frequency domain, there is recorded the high-frequency domain information extracted by the spatial frequency characteristic analysis device 250. By these, the characteristic data 50 is generated.

In FIG. 1 again, the characteristic data storage device 270 accumulates the characteristic data generated by the characteristic data generation device 260. The characteristic data storage device 270 includes a recording medium, such as a hard disk and a memory.

Incidentally, the video analysis device 200 may have the time information inputted separated from the video data. In this case, the video analysis device 200 can be constructed not to have the time information extraction device 210. Moreover, in addition to the chromatic characteristic analysis device 220, the luminance characteristic analysis device 230, the motion characteristic analysis device 240, and the spatial frequency characteristic analysis device 250, another characteristic analyzing device for analyzing another characteristic of the video may be added, so that an analysis result by the other characteristic analyzing device may be included in the characteristic data. Moreover, a plurality of characteristic data may be generated on the basis of each of the analysis results analyzed by the chromatic characteristic analysis device 220, the luminance characteristic analysis device 230, the motion characteristic analysis device 240, and the spatial frequency characteristic analysis device 250. In other words, the characteristic data may not be integrated by the frame unit.

In FIG. 1, the editing control device 300 has a characteristic specification device 310, a scene identification device 320, a history holding device 330, and a history comparison device 340.

The characteristic specification device 310 is constructed such that a user can specify the characteristics of a scene to be identified as an editing target, from the video associated with the video data. The characteristic specification device 310 has a GUI (Graphical User Interface) for the user to input the characteristics of the scene to be specified as the editing target.

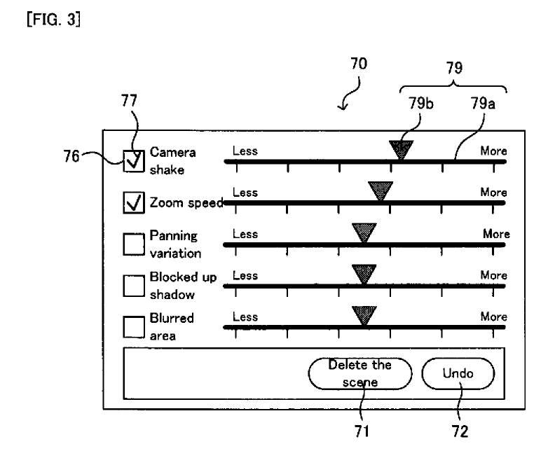

FIG. 3 is a view showing the GUI in the characteristic specification device in the first embodiment.

As shown in FIG. 3, the characteristic specification device 310 can select at least one of “camera shake”, “zoom speed”, “panning variation”, “blocked up shadow”, and “blurred area”, as the types of the characteristics of the scene to be identified as the editing target, by the user inputting a check mark 77 in a check box 76 of a GUI 70. In the example in FIG. 3, the “camera shake” and the “zoom speed” in each of which the check mark 77 is inputted in the check box 76 are selected as the types of the characteristics of the scene to be identified as the editing target. Moreover, the characteristic specification device 310 can specify the level (or index value) of the characteristics of the scene to be identified as the editing target by the user operating a level specification device 79 (i.e. displacing a level display device 79b relatively horizontally to a level scale 79a).

Incidentally, the “blocked up shadow” is a criterial characteristic to judge whether or not a scene backlighted in the filming is identified as the editing target. The “blurred area” is a criterial characteristic to judge whether or not a scene out of focus in the filming (i.e. blurred scene) is identified as the editing target.

The GUI 170 is provided with editing buttons 71 and 72. By the editing button 71 being pressed (or selected) by the user, video editing (the deletion of the scene to be identified by the scene identification device 320 in the embodiment) is performed. By the editing button 72 being pressed by the user, the video editing most recently performed is canceled.

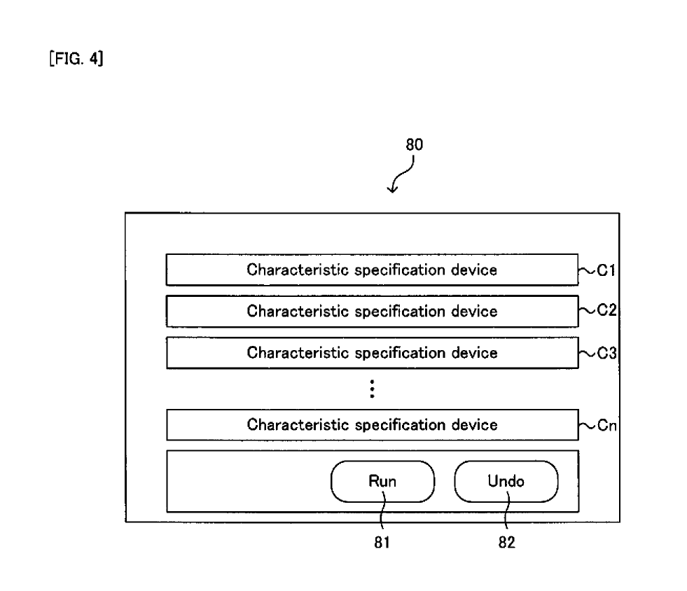

As shown as a modified example in FIG. 4, the characteristic specification device may have a GUI 80, instead of the aforementioned GUI 70 with reference to FIG. 3. FIG. 4 is a view with the same concept as in FIG. 3 in the modified example.

In other words, the characteristic specification device may specify the type and level of the scene to be identified as the editing target by the user inputting the level of the characteristics corresponding to each of characteristic specification devices C1 to Cn (wherein n is a natural number) of the GUI 80 to respective one of the characteristic specification devices C1 to Cn. By an editing button 81 being pressed by the user, the video editing may be performed, and by an editing button 82 being pressed by the user, the video editing most recently performed may be canceled.

In FIG. 1 and FIG. 3 again, the characteristic specification device 310 generates control data and outputs it to the scene identification device 320 when the editing button 71 of the GUI 70 is pressed by the user.

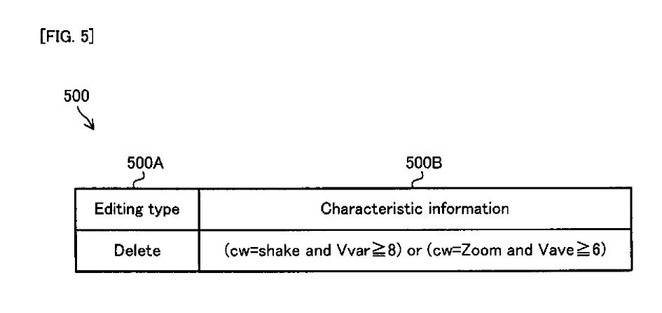

FIG. 5 is conceptual view conceptually showing one example of the control data in the first embodiment.

As shown in FIG. 5, control data 500 is provided with an item 500A associated with an editing type and an item 500B associated with characteristic information. The item 500A associated with the editing type indicates the type of the editing specified by the user (i.e. the editing type). The item 500B associated with the characteristic information indicates information about the characteristics specified by the user (i.e. the characteristic information), as the characteristics of the scene to be identified as the editing target. The example in FIG. 5 shows the control data generated when the editing button 71 is pressed by the user in FIG. 3. The control data 500 means that characteristics which are “the camera shake with a vibration of 8 or more, or the zoom with a speed of 6 or more” are specified and that the editing type of deleting a scene with characteristics which match the specified characteristics is specified. Incidentally, “Delete” in the item 500A associated with the editing type means “scene deletion”, “cw=shake and Vvar□8” in the item 500B associated with the characteristic information means the camera shake with a variation of 8 or more, and “cw=Zoom and Vave□6” means the zoom with a speed of 6 or more.

In FIG. 1 again, the scene identification device 320 identifies the scene with characteristics which match the characteristics specified by the characteristics specification device 310, from the video associated with the video data. More specifically, the scene identification device 320 identifies the scene with characteristics which match the characteristics specified by the characteristics specification device 310, by searching for the characteristic data (refer to FIG. 2) accumulated in the characteristic data storage device 270 in accordance with the characteristic information (refer to FIG. 5) included in the control data inputted from the characteristic specification device 310. In other words, as a scene with the characteristics which match the characteristics of “the camera shake with a vibration of 8 or more” described with reference to FIG. 5, it identifies a scene which is provided with frames having frame numbers that the type of the item 50D associated with the camera work in FIG. 2 is the “camera shake” and that a speed distribution is 8 or more. Moreover, as a scene with the characteristics which match the characteristics of “the zoom with a speed of 6 or more” described with reference to FIG. 5, it identifies a scene which is provided with frames having frame numbers that the type of the item 50D associated with the camera work in FIG. 2 is the “zoom and that an average speed is 6 or more.

Moreover, the scene identification device 320 generates scene information including the start and end time points of the identified scene and outputs it to the history holding device 330 described later.

The history holding device 330 holds a history of the scene information inputted from the scene identification device 320. The history holding device 330 includes a recording medium, such as a hard disk and a memory.

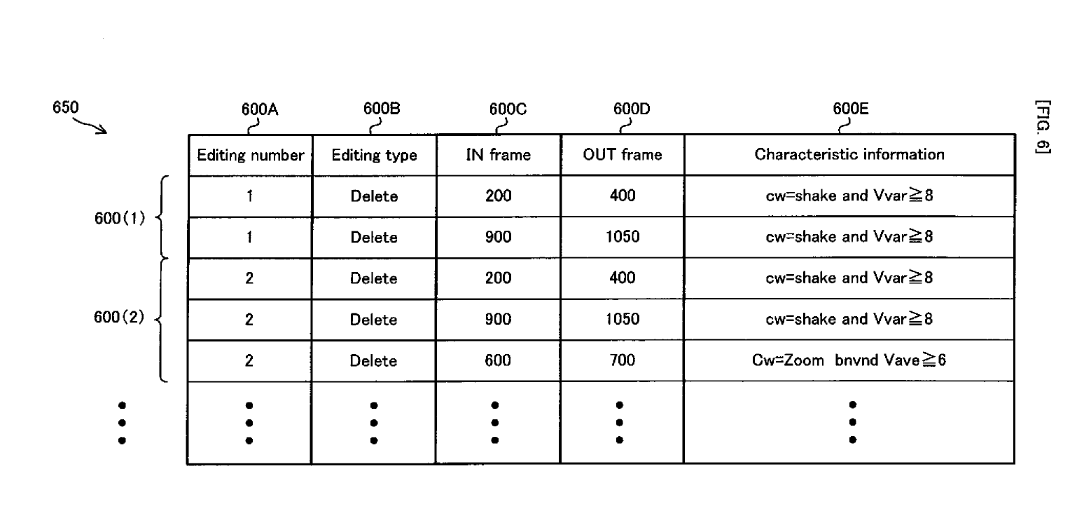

FIG. 6 is a conceptual view conceptually showing one example of the history of the scene information held by the history holding device.

In FIG. 6, a history 650 of the scene information is provided with a plurality of pieces of scene information 600 (specifically, scene information 600(1), 600(2), and so on). Each piece of scene information is provided with an item 600A associated with an editing number, an item 600E associated with an editing type, an item 600C associated with an IN frame, an item 600D associated with an OUT frame, and an item 600E associated with characteristic information. The item 600A associated with the editing number is a number uniquely determined to distinguish the specified order every time the characteristics of the scene to be identified as the editing target are specified by the user (in other words, every time the control data is generated by the characteristic specification device 310). The item 600B associated with the editing type and the item 600E associated with the characteristic information correspond to the item 500A associated with the editing type and the item 500B associated with the characteristic information 500B in the control data described above with reference to FIG. 5, respectively. The item 600C associated with the IN frame is the frame number of a start frame from which the scene identified by the scene identification device 320 starts. The item 600D associated with the OUT frame is the frame number of an end frame at which the scene identified by the scene identification device 320 ends. In the example in FIG. 6, the scene information 600(1) shows that there are two scenes (two rows) which are identified as the scene in which the item 600E associated with the characteristic information is “the camera shake with a vibration of 8 or more” (also refer to FIG. 5) and in which the item 600B associated with the editing type is “the scene deletion” (also refer to FIG. 5), by the first editing operation which is performed by the user and in which the item 600A associated with the editing number is “1”. Moreover, the scene information 600(1) shows that the frame number of the start frame of one of the two scenes is 200 and the frame number of the end frame of the one scene is 400, and that the frame number of the start frame of the other scene is 900 and the frame number of the end frame of the other scene is 1050. Moreover, the scene information 600(2) shows that there are three scenes (three rows) which are identified as the scene in which the item 600E associated with the characteristic information is “the camera shake with a vibration of 8 or more, or the zoon with a speed of 6 or more” (also refer to FIG. 5) and in which the item 600B associated with the editing type is “the scene deletion” (also refer to FIG. 5), by the second editing operation which is performed by the user and in which the item 600A associated with the editing number is “2”. Moreover, the scene information 600(2) shows that the frame number of the start frame of one of the three scenes is 200 and the frame number of the end frame of the one scene is 400, that the frame number of the start frame of another scene is 900 and the frame number of the end frame of the other scene is 1050, and that the frame number of the start frame of the remaining scene is 600 and the frame number of the end frame of the remaining scene is 700.

In FIG. 1 again, the history comparison device 340 is adapted to compare at least two pieces of scene information included in the history of the scene information held in the history holding device 330, thereby extracting a different portion in which the pieces of scene information are different from each other or a common portion in which the pieces of scene information are common with each other.

In FIG. 6, for example, as the different portion between the scene information 600(1) and the scene information 600(2), a portion with a frame number of the start frame of 600 and with a frame number of the end frame of 700, which is included in the scene information 600(2) and in which the item 600E associated with the characteristic information is “the zoom with a speed of 6 or more” (i.e. cw=Zoom and Vave□6), is extracted by the history comparison device 340. Alternatively, for example, as the common portion between the scene information 600(1) and the scene information 600(2), a portion with a frame number of the start frame of 200 and with a frame number of the end frame of 400 and a portion with a frame number of the start frame of 900 and with a frame number of the end frame of 1050, which are included in both the scene information 600(1) and the scene information 600(2) and in which the item 600E associated with the characteristic information is “the camera shake with a vibration of 8 or more” (i.e. cw=shake and Vvar□8), are extracted by the history comparison device 340.

In FIG. 1, the editing result confirmation device 400 is one example of the “presenting device” of the present invention. The editing result confirmation device 400 is provided with an editing result display device 410 and a reproduction device 420.

The editing result display device 410 graphically displays the scene information (more specifically, the aforementioned different portion or common portion) inputted from the editing control device 300 (more specifically, the history comparison device 340), as the editing result, on the screen of a display owned by the editing result confirmation device 400 or externally provided.

The reproduction device 420 is adapted to reproduce the scene corresponding to the different portion or common portion of the scene information. In other words, the reproduction device 420 is adapted to read the video data of the scene corresponding to the different portion or common portion of the scene information from the video data storage device 100 and to reproduce it.

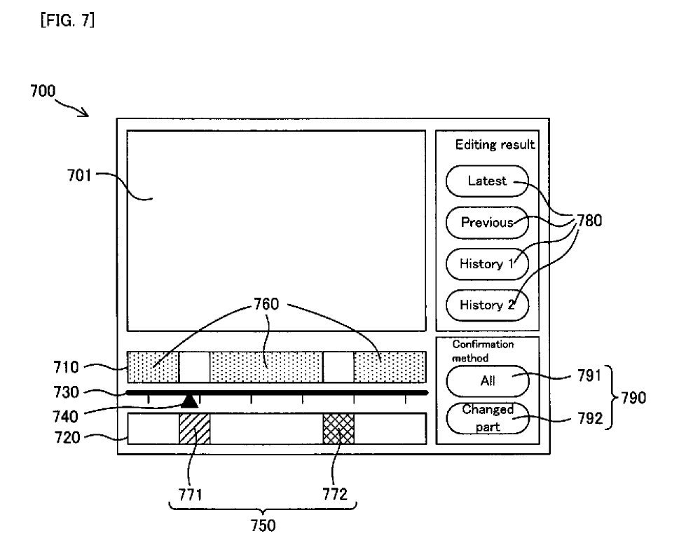

FIG. 7 is a view showing one example of the display by the editing result display device.

As shown in FIG. 7, on a display screen 700 on which the editing result is displayed by the editing result display device 410, there are displayed a video display area 701, a first scene information display device 710, a second scene information display device 720, a scale device 730, a reproduction position display 740, a scene information selection button 780, and a confirmation method selection button 790.

In the video display area 701, the scene reproduced by the reproduction device 420 is displayed.

The first scene information display device 710 displays the position in the entire video of the scene without the characteristics which match the characteristics identified by the user as the editing target (i.e. the scene that is not identified by the user), from the video associated with the video data. The first scene information display device 710 is displayed in a rectangular shape as a whole, and an unidentified part display 760 which shows the position of the scene that is not identified by the user is displayed in the rectangle.

The second scene information display device 720 displays the position in the entire video of the scene with the characteristics which match the characteristics identified by the user as the editing target (i.e. the scene that is identified by the user), from the video associated with the video data. The second scene information display device 720 is displayed in a rectangular shape as a whole as in the first scene information display device 710, and an identified part display 750 which shows the position of the scene that is identified by the user is displayed in the rectangle.

The identified part display 750 is displayed as a different portion display 771 and a common portion display 772.

The different portion display 771 displays the position of the scene corresponding to the different portion in which one scene information and another scene information are different from each other if the user selects the one scene information and the other scene information included in the history 650 of the scene information are selected by using the scene information selection button 780 described later.

The common portion display 772 displays the position of the scene corresponding to the common portion in which one scene information and another scene information are common with each other if the user selects the one scene information and the other scene information included in the history 650 of the scene information are selected by using the scene information selection button 780 described later.

The different portion display 771 and the common portion display 772 are displayed in different colors or patterns, which are different from each other, and this enables the user to distinguish between the different portion display 771 and the common portion display 772.

More specifically, for example, if the user selects the scene information 600(1) and the scene information 600(2) in the history 650 of the scene information shown in FIG. 6, the different portion display 771 displays the portion with a frame number of the start frame of 600 and with a frame number of the end frame of 700, which is the different portion and in which the item 600E associated with the characteristic information is “the zoom with a speed of 6 or more” (i.e. cw=Zoom and Vave□6), and the common portion display 772 displays the portion with a frame number of the start frame of 200 and with a frame number of the end frame of 400 and the portion with a frame number of the start frame of 900 and with a frame number of the end frame of 1050, which are the common portion and in which the item 600E associated with the characteristic information is “the camera shake with a vibration of 8 or more” (i.e. cw=shake and Vvar□8).

As described above, the user can distinguish between the different portion display 771 and the common portion display 772, so that the user can easily determine the editing operation to be performed next in order to obtain the user's desired editing result, for example, on the basis of the different portion display 771 or the common portion display 772.

The scale device 730 is displayed in association with one side of each rectangle of the first scene information display device 710 and the second scene information display device 720, and the entire length of the scale device 730 means the length of the entire video associated with the video data.

The reproduction position display 740 shows the reproduction position of the scene reproduced by the reproduction device 420 (in other words, displayed in the video display area 701). In other words, by the reproduction position display 740 being displaced along the scale device 730 in accordance with the reproduction position of the scene reproduced by the reproduction device 420, the user can recognize the reproduction position.

The scene information selection button 780 is a GUI for the user selecting the scene information to be displayed on the first scene information display device 710 and the second scene information display device 720, from the history 650 of the scene information.

The confirmation method selection button 790 is a GUI for the user selecting a display method of displaying the scene in the video display area 701, and the user can select whether all the scenes corresponding to the identified part display 750 are reproduced and displayed or only the scene corresponding to the different portion display 771 of the identified part display 750 is reproduced and displayed. In other words, the confirmation method selection button 790 is provided with selection buttons 791 and 792. The display method of reproducing and displaying all the scenes corresponding to the identified part device 750 is selected by pressing the selection button 791, and the display method of reproducing and displaying only the scene corresponding to the different portion display 771 of the identified part display 750 is selected by pressing the selection button 792.

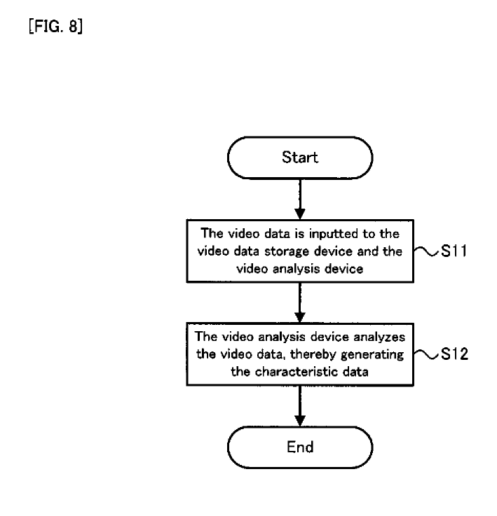

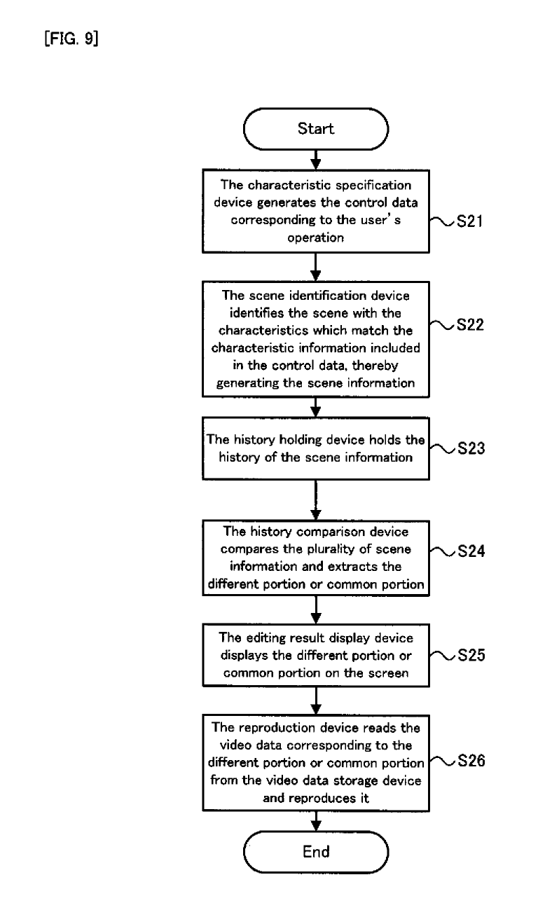

Next, the operations of the motion picture editing apparatus in the first embodiment will be explained with reference to FIG. 8 and FIG. 9. FIG. 8 and FIG. 9 are flowcharts conceptually showing the operations of the motion picture editing apparatus in the first embodiment. Incidentally, FIG. 8 mainly shows the operations associated with the video data storage device and the video analysis device in the first embodiment, and FIG. 9 mainly shows the operations associated with the editing control device and the editing result confirmation device in the first embodiment.

Hereinafter, firstly, an explanation will be given on the basic operations of the motion picture editing apparatus 10 when the user edits the video data. Incidentally, when the user edits the video data, firstly, the operations associated with the video data storage device and the video analysis device described later with reference to FIG. 8 are performed. Then, the operations associated with the editing control device and the editing result confirmation device described later with reference to FIG. 9 are repeated, typically a plurality of times.

In FIG. 8, firstly, the video data is inputted to the video data storage device 100 and the video analysis device 200 (step S11). In other words, when the editing operation of editing the video data is started by the user, the video data is inputted to each of the video data storage device 100 and the video analysis device 200. At this time, the video data storage device 100 accumulates the inputted video data.

Then, the video analysis device 200 analyzes the video data, thereby generating the characteristic data (step S12). In other words, the video analysis device 200 firstly extracts the time information by using the time information extraction device 210 and analyzes the video data by using the chromatic characteristic analysis device 220, the luminance characteristic analysis device 230, the motion characteristic analysis device 240, and the spatial frequency characteristic analysis device 250. Then, the video analysis device 200 generates the characteristic data 50 described above with reference to FIG. 2, on the basis of the time information extracted by the time information extraction device 210 and the analysis results (i.e. the chromatic characteristics, the luminance characteristics, the motion characteristics, and the spatial frequency characteristics) obtained by analyzing the video data by using the chromatic characteristic analysis device 220, the luminance characteristic analysis device 230, the motion characteristic analysis device 240, and the spatial frequency characteristic analysis device 250. The generated characteristic data is accumulated in the characteristic data storage device 270.

Then, in FIG. 9, the characteristic specification device 310 generates the control data corresponding to the user's editing operation (step S21). In other words, the characteristic specification device 310 generates the control data described above with reference to FIG. 5, on the basis of the characteristics of the scene to be identified as the editing target, which are inputted by the user through the GUI 70 described above with reference to FIG. 3.

Then, the scene identification device 320 identifies the scene with the characteristics which match the characteristic information included in the control data, thereby generating the scene information (step S22). In other words, the scene identification device 320 searches for the characteristic data (refer to FIG. 2) accumulated in the characteristic data storage device 270 in accordance with the characteristic information (refer to FIG. 5) included in the control data generated by the characteristic specification device 310, thereby identifying the scene with the characteristics which match the characteristics specified by the characteristic specification device 310.

Then, the history holding device 330 holds the history of the scene information (step S23). In other words, the history holding device 330 holds the history 650 of the scene information described above with reference to FIG. 6, thereby saving or managing the scene information inputted from the scene identification device 320 in inputted order. In other words, the history holding device 330 applies the editing number which allows the inputted order of the scene information to be distinguished, to the scene information every time the scene information generated by the scene identification device 320 is inputted.

Then, the history comparison device 340 compares the plurality of pieces of scene information, and it extracts the different portion or common portion (step S24). In other words, the history comparison device 340 extracts the different portion in which the two pieces of scene information are different from each other or the common portion in which the two pieces of scene information are common, with regard to the two pieces of scene information specified by the user (e.g. the scene information 600(1) and 600(2)), as described above with reference to FIG. 6.

Then, the editing result display device 410 displays the different portion or common portion on the screen (step S25). In other words, the editing result display device 410 displays the unidentified part display 760 which shows the position in the entire video of the scene that is not identified by the user, on the first scene information display device 710, and it also displays the identified part display 750 which shows the position in the entire video of the scene that is specified by the user, on the second scene information display device 720, as described above with reference to FIG. 7. The editing result display device 410 displays the identified part display 750 as the different portion display 771 and the common portion display 772. Thus, the user can distinguish between the different portion and the common portion of the specified two scene information by looking at the different portion display 771 and the common portion display 772. Therefore, the user can easily determine the editing operation to be performed next in order to obtain the user's desired editing result, for example, on the basis of the different portion or common portion. As a result, the user can easily perform the editing operation.

Then, the reproduction device 420 reads the video data corresponding to the different portion or common portion from the video data storage device 100 and reproduces it (step S26). In other words, the reproduction device 420 reproduces the scene corresponding to the different portion or common portion extracted by the history comparison device 340 (i.e. the scene corresponding to the different portion display 771 or common portion display 772 described above with reference to FIG. 7), from the video data accumulated in the video data storage device 100, in accordance with the user's instruction. The reproduced video is displayed in the video display area 701 on the display screen 700 (refer to FIG. 7). Thus, the user can easily judge whether or not the scene corresponding to the different portion or common portion is the user's desired scene. At this time, the user can recognize the reproduction position by using the reproduction position display 740 (refer to FIG. 7).

After confirming the video displayed in the video display area 701 (i.e. the scene corresponding to the different portion display 771 or common portion display 772), the user changes the characteristics of the scene to be identified as the editing target if the editing result is not the user's desired result, and the user specifies it again by using the characteristic specification device 310 (the step S21). The series of processes in the step S21 to the step S25 is repeated until the editing result matches the user's desired result.

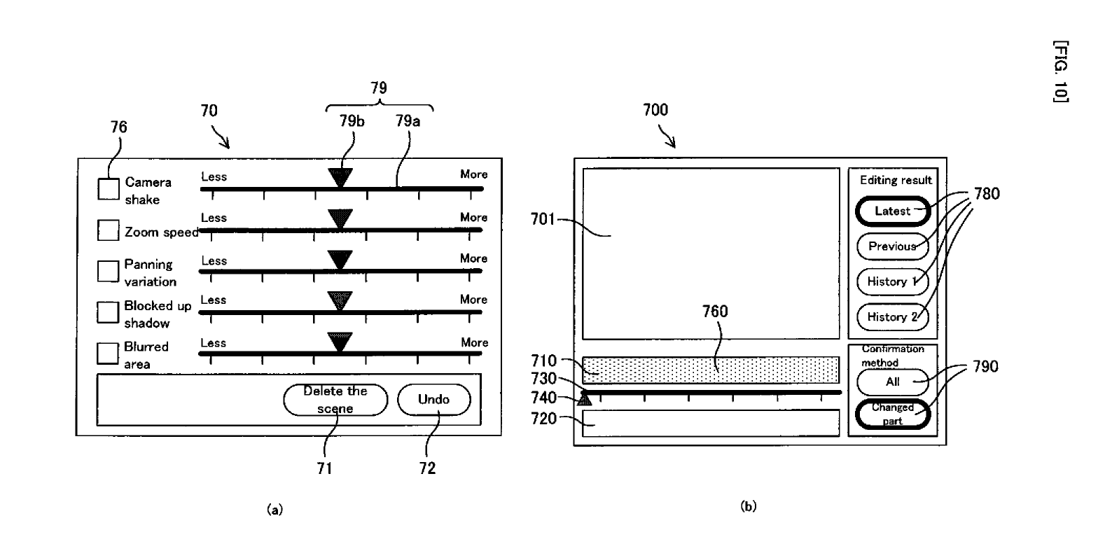

Next, an explanation will be given on one example of the editing result displayed by the editing result display device when the user edits the video data by using the motion picture editing apparatus in the first embodiment, with reference to FIGS. 10 to FIGS. 13. Each of FIGS. 10 to FIGS. 13 are views showing one example of the editing result displayed by the editing result display device when the user edits the video data by using the motion picture editing apparatus in the first embodiment, and (a) in each drawing shows the characteristics specified by the characteristic specification device in association with FIG. 3, and (b) shows the editing result displayed by the editing result display device when the characteristics are specified as shown in (a), in association with FIG. 7. Moreover, each of FIGS. 10 to FIGS. 13 shows one example of the editing result by the editing result display device when the characteristics are specified by the characteristic specification device in this order. Each of FIGS. 10 to FIGS. 13 corresponds to the operations associated with the editing control device and the editing result confirmation device described above with reference to FIG. 9.

As shown in FIG. 10, if the user does not input the check mark 77 in any of the check boxes 76 of the GUI 70 (refer to FIG. 3) (i.e. if the characteristics are not specified by the characteristic specification device 310), the unidentified part display 760 is displayed in the entire rectangle of the first scene information display device 710 such that it is indicated to the first scene information display device 710 on the display screen 700 that the entire video is the scene without the characteristics which match the characteristics identified as the editing target. In other words, the identified part display 750 (refer to FIG. 7) is not displayed on the second scene information display device 720.

Incidentally, in the examples in FIGS. 10 to FIGS. 13, a button associated with the “latest” of the scene information selection buttons 780 is selected, and the scene information associated with the latest editing operation by the user and the scene information associated with the editing operation immediately before the latest editing operation are selected as the scene information to be displayed on the first scene information display device 710 and the second scene information display device 720. Moreover, a button associated with a “changed part” of the confirmation method selection button 790 (i.e. the selection button 792 described above with reference to FIG. 7) is selected, and the display method of reproducing and displaying only the scene corresponding to the different portion display 771 is selected.

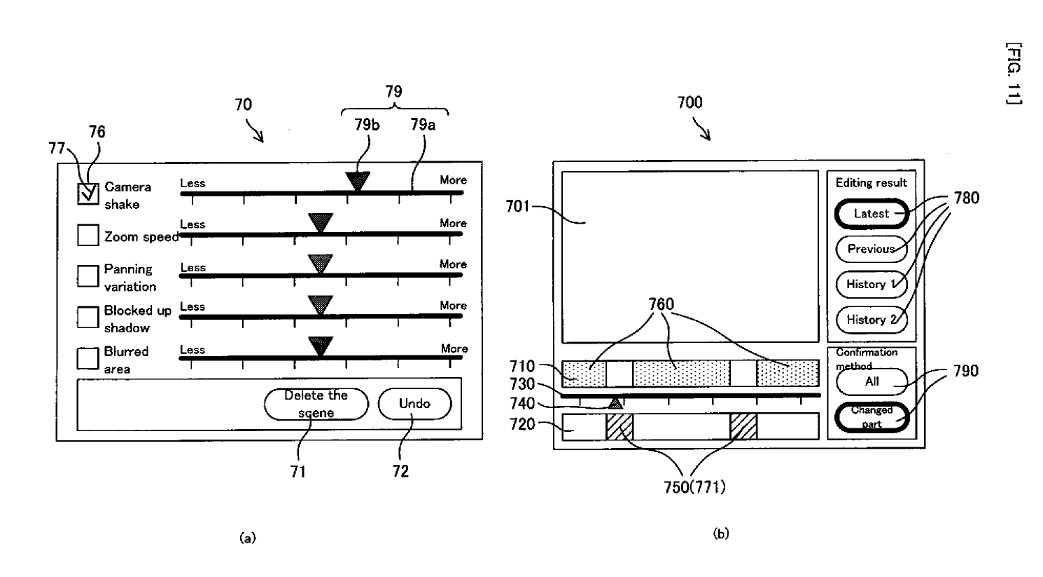

Then, as shown in FIGS. 11, if the user inputs the check mark 77 in the check box 76 corresponding to the “camera shake” (i.e. the “camera shake” is specified with the level thereof by the characteristic specification device 310 as the type of the characteristics and if the “scene deletion” is performed), the identified part display 750 which shows the position (i.e. the start and end time points of the scene) of the scene with the characteristics which match the specified characteristics (i.e. the scene including the “camera shake” with a higher level than the specified level) is displayed on the second scene information display device 720.

Here, in FIGS. 10, there is no scene with the characteristics which match the characteristics identified as the editing target as described above (i.e. the identified part display 750 is not displayed). Thus, the identified part display 750 is displayed as the different portion display 771 in FIGS. 11.

Moreover, the scene corresponding to the different portion display 771 is reproduced by the reproduction device 420 and displayed in the video display area 701. Thus, the user can easily perform the operation of confirming the scene identified as the editing target. In other words, by displaying the scene corresponding to the different portion display 771 in the video display area 701, it is possible to easily confirm the difference (in other words, the changed part) between the editing result by the latest editing operation and the editing result by the editing operation immediately before the latest editing operation; namely, it is possible to reduce the time required for the confirmation of the editing result, in comparison with a case where the user confirms all the edited video at each time of the editing operation.

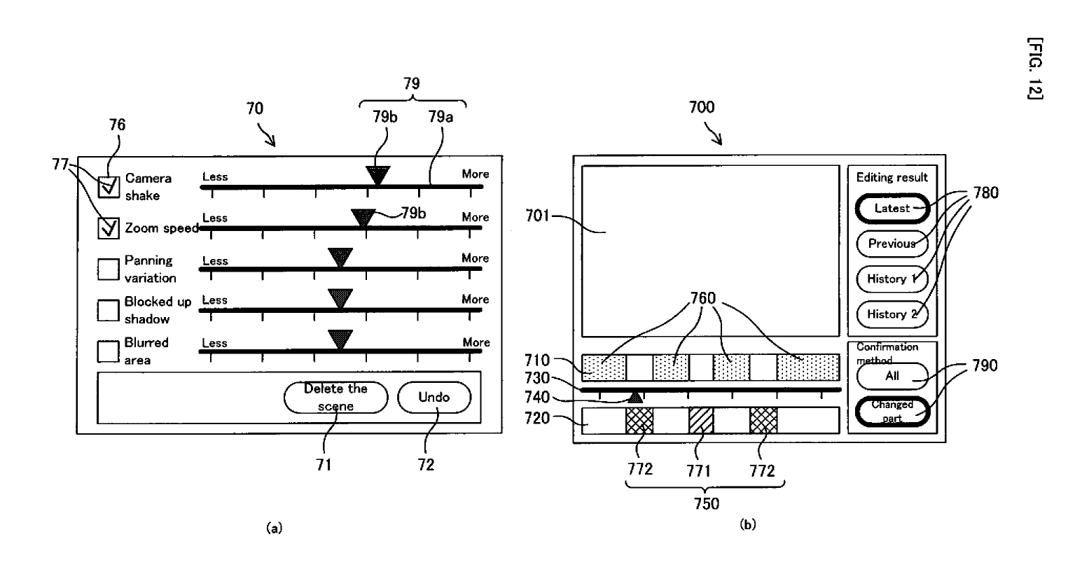

Then, as shown in FIG. 12, if the user inputs the check marks 77 in the check boxes 76 corresponding to the “camera shake” and the “zoom speed” and presses the editing button 71 (i.e. when the “camera shake” and the “zoom speed” are specified with the level thereof by the characteristic specification device 310 as the type of the characteristics and if the “scene deletion” is performed), the identified part display 750 which shows the position of the scene with the characteristics which match the specified characteristics (i.e. the scene including the “camera shake” with a higher level than the specified level and the scene including the “zoon speed” with a higher level than the specified level) is displayed on the second scene information display device 720. Here, in particular, the identified part display 750 is displayed as the different portion display 771 and the common portion display 772. In other words, of the identified part display 750, the identified part display 750 showing the scene that is the same as the scene identified in FIG. 11 is displayed as the common portion display 772, and the identified part display 750 showing the scene that is different from the scene identified in FIG. 11 is displayed as the different portion display 771. Namely, the scene including the “camera shake” with a higher level than the level specified in FIG. 12 is displayed as the common portion display 772 because it is the same as the scene identified in FIG. 11, and the scene including the “zoom speed” with a higher level than the level specified in FIG. 12 is displayed as the different portion display 771 because it is different from the scene identified in FIG. 11. Thus, the user can recognize, by looking at the different portion display 771, the scene added as the target of the “scene deletion” by adding the “zoom speed” in addition to the “camera shake” as the characteristics of the scene in FIG. 12 after identifying the “camera shake” as the characteristics of the scene in FIG. 11. Moreover, the scene corresponding to the different portion display 771 is reproduced by the reproduction device 420 and displayed in the video display area 701. Thus, the user can confirm only the scene corresponding to the different portion display 771, and the user can reduce the time and energy or effort required for the editing operation. In other words, in FIGS. 12, the user can omit the confirmation of the scene corresponding to the common portion display 772 showing the same scene as the scene identified in FIG. 11.

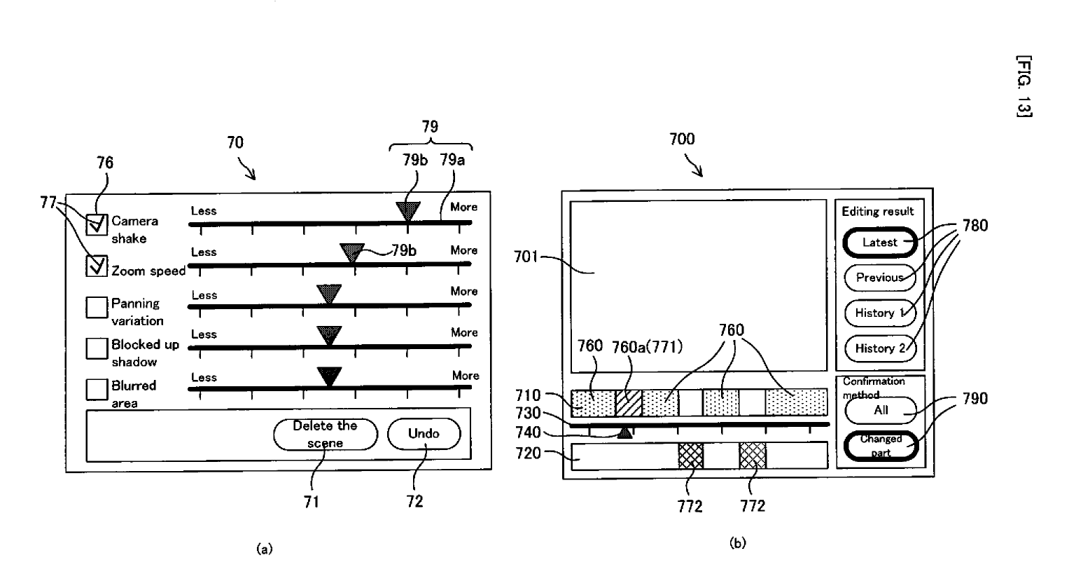

Then, as shown in FIG. 13, if the user inputs the check marks 77 in the check boxes 76 corresponding to the “camera shake” and the “zoom speed”, specifies the level of the “camera shake” with a higher value than the level of the “camera shake” specified in FIG. 12, and presses the editing button 71, the identified part display 750 which shows the position of the scene with the characteristics which match the specified characteristics is displayed on the second scene information display device 720. Here, in particular, the identified part display 750 is displayed as the common portion display 772 showing the scene that is the same as the scene identified in FIG. 12. Moreover, one portion 760a of the unidentified part display 760 is displayed as the different portion display 771 showing the scene that is not identified in FIG. 13, of the scene identified in FIG. 12. Thus, the user can recognize, by looking at the different portion display 771 (in other words, the one portion 760a of the unidentified part display 760), the scene removed from the scene that is the target of the “scene deletion” and that is identified in FIG. 12 by specifying the level of the “camera shake” with a higher value as the characteristics of the scene in FIG. 13. Moreover, the scene corresponding to the different portion display 771 is reproduced by the reproduction device 420 and displayed in the video display area 701. Thus, the user can confirm only the scene corresponding to the different portion display 771, and the user can reduce the time and energy or effort required for the editing operation. In other words, by confirming only the scene with the characteristics which match the added characteristics, the user can reduce the time and energy required for the editing, in comparison with the case where the user confirms all the edited video. Here, if the user confirms only the scene with the characteristics which match the added characteristics, the user remembers the previous editing result to the extent that the user can judge whether or not the editing result is the user's desired result. Thus, by confirming only the scene with the characteristics which match the added characteristics, the user can determine the editing operation to be performed next in order to obtain the user's desired editing result.

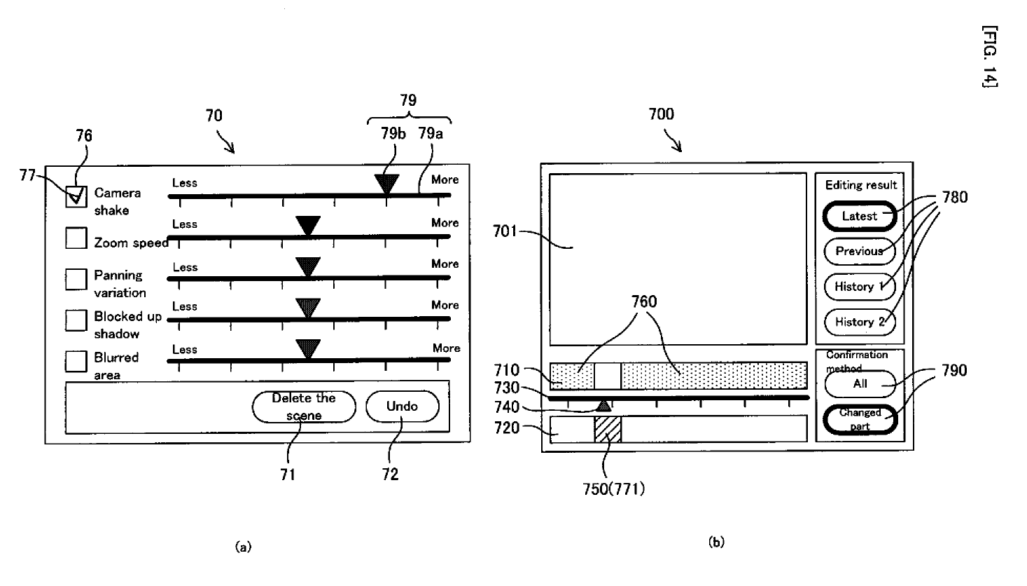

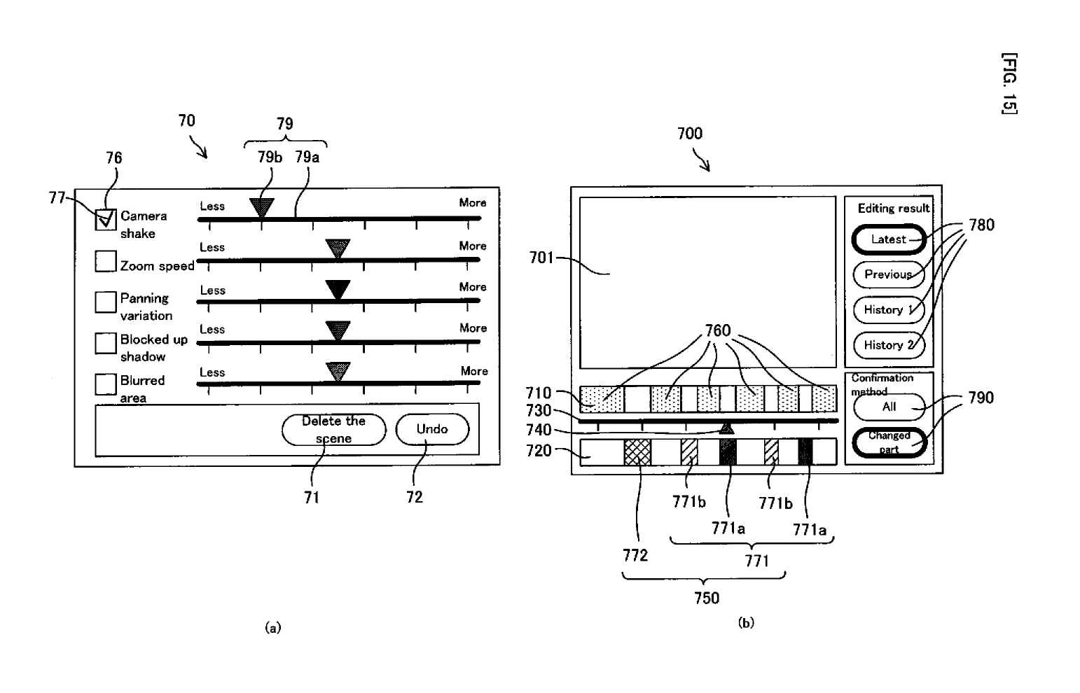

Next, with reference to FIGS. 14 and FIGS. 15, an explanation will be given on another example of the editing result displayed by the editing result display device when the user edits the video data by using the motion picture editing apparatus in the first embodiment. Each of FIG. 14 and FIG. 15 are views showing one example of the editing result displayed by the editing result display device when the user edits video data by using the motion picture editing apparatus in the first embodiment, and (a) in each drawing shows the characteristics specified by the characteristic specification device, and (b) shows the editing result displayed by the editing result display device when the characteristics are specified as shown in (a), in association with FIG. 7. Moreover, FIG. 14 and FIG. 15 show another example of the editing result by the editing result display device when the characteristics are specified by the characteristic specification device in this order. Each of FIG. 14 and FIG. 15 corresponds to the operations associated with the editing control device and the editing result confirmation device described above with reference to FIG. 9.

Incidentally, in the examples in FIG. 14 and FIG. 15, the button associated with the “latest” of the scene information selection buttons 780 is selected, and the scene information associated with the latest editing operation by the user and the scene information associated with the editing operation immediately before the latest editing operation are selected as the scene information to be displayed on the first scene information display device 710 and the second scene information display device 720. Moreover, the button associated with the “changed part” of the confirmation method selection button 790 (i.e. the selection button 792 described above with reference to FIG. 7) is selected, and the display method of reproducing and displaying only the scene corresponding to the different portion display 771 is selected.

As shown in FIG. 14, in the editing of the video data, firstly, if the user inputs the check mark 77 in the check box 76 corresponding to the “camera shake”, the identified part display 750 showing the position of the scene with the characteristics which match the specified characteristics is displayed on the second scene information display device 720. At this time, the identified part display 750 is displayed as the different portion display 771.

As shown in FIGS. 15, if the user inputs the check mark 77 in the check box 76 corresponding to the “camera shake”, specifies the level of the “camera shake” with a lower level than the level specified in FIGS. 14, and presses the editing button 71, the identified part display 750 showing the position of the scene with the characteristics which match the specified characteristics is displayed on the second scene information display device 720. At this time, the identified part display 750 is displayed as the common portion display 772 showing the scene that is the same as the scene identified in FIG. 14 and the different portion display 771 showing the scene that is different from the scene identified in FIG. 14. Here, in particular, the different portion display 771 is displayed as a first display 771a, which shows the position of the scene with the level of the “camera shake” relatively close to the specified level, and a second display 771b, which shows the position of the scene with the level of the “camera shake” relatively far from the specified level. Thus, by the user selectively reproducing the scene corresponding to the first display 771a or second display 771b by using the reproduction device 420 and displaying it in the video display area 701, the user can confirm the editing result, more quickly. In other words, the user can omit the confirmation of the scene corresponding to the first display 771a or second display 771b. In particular, by confirming the scene corresponding to the first display 771a, i.e. the scene with the level of the “camera shake” relatively close to the specified level, the user can easily judge whether the level of the “camera shake” is appropriate, and also whether to increase or reduce the level of the “camera shake” in the next operation.

The present invention can be also applied to a HDD recorder, DVD recorder, video editing software, video-editing-function cam recorder, or the like, in addition to the motion picture editing apparatus explained in the aforementioned embodiment.

The present invention is not limited to the aforementioned examples, but various changes may be made, if desired, without departing from the essence or spirit of the invention which can be read from the claims and the entire specification. A motion picture editing apparatus and a motion picture editing method, all of which involve such changes, are also intended to be within the technical scope of the present invention.

1-8. (canceled)

9. A motion picture editing apparatus comprising:
a motion picture analyzing device for analyzing a motion picture, thereby obtaining characteristics of the motion picture;
a specifying device capable of specifying characteristics of a scene to be identified as an editing target, of the motion picture;
an identifying device for identifying a scene with characteristics which match the specified characteristics of the motion picture, as the editing target;
a presenting device for presenting scene information including start and end time points of the identified scene of the motion picture;
a history holding device for holding a history of the scene information associated with the identified scene; and
a comparing device for comparing at least two pieces of scene information included in the held history, thereby extracting a different portion in which the at least two pieces of scene information are different from each other or a common portion in which the at least two pieces of scene information are common with each other.

10. The motion picture editing apparatus according to claim 9, wherein
the motion picture analyzing device comprises at least one of characteristic analyzing devices which are:
a chromatic characteristic analyzing device for analyzing chromatic characteristics in each of a plurality of frames which constitute the motion picture;
a luminance characteristic analyzing device for analyzing luminance characteristics in each of the plurality of frames which constitute the motion picture;
a motion characteristic analyzing device for analyzing motion characteristics in each of the plurality of frames which constitute the motion picture; and
a spatial frequency characteristic analyzing device for analyzing spatial frequency characteristics in each of the plurality of frames which constitute the motion picture.

11. The motion picture editing apparatus according to claim 9, wherein
the specifying device can specify a type and level of the characteristics of the scene to be identified, and
the identifying device judges whether or not the characteristics of the specified type match the specified characteristics on the basis of the specified level.

12. The motion picture editing apparatus according to claim 9, wherein the presenting deice has a reproducing device for reproducing the identified scene.

13. The motion picture editing apparatus according to claim 9, wherein the presenting deice has a reproducing device for reproducing a scene corresponding to the different portion or the common portion.

14. A motion picture editing method comprising:
a motion picture analyzing process of analyzing a motion picture, thereby obtaining characteristics of the motion picture;
a specifying process of specifying characteristics of a scene to be identified as an editing target, of the motion picture;
an identifying process of identifying a scene with characteristics which match the specified characteristics of the motion picture, as the editing target;
a presenting process of presenting scene information including start and end time points of the identified scene of the motion picture;
a history holding process of holding a history of the scene information associated with the identified scene; and
a comparing process of comparing at least two pieces of scene information included in the held history, thereby extracting a different portion in which the at least two pieces of scene information are different from each other or a common portion in which the at least two pieces of scene information are common with each other.

15. A computer-readable medium containing a computer program for making a computer function as:
a motion picture analyzing device for analyzing a motion picture, thereby obtaining characteristics of the motion picture;
a specifying device capable of specifying characteristics of a scene to be identified as an editing target, of the motion picture;
an identifying device for identifying a scene with characteristics which match the specified characteristics of the motion picture, as the editing target; a presenting device for presenting scene information including start and end time points of the identified scene of the motion picture;
a history holding device for holding a history of the scene information associated with the identified scene; and
a comparing device for comparing at least two pieces of scene information included in the held history, thereby extracting a different portion in which the at least two pieces of scene information are different from each other or a common portion in which the at least two pieces of scene information are common with each other.

16. The motion picture editing apparatus according to claim 9, wherein the presenting device further presents the different portion or the common portion.

17. The motion picture editing method according to claim 14, wherein the presenting process further presents the different portion or the common portion.

18. The computer-readable medium according to claim 15, wherein the presenting device further presents the different portion or the common portion.
